(19) United States
(12) Patent Application Publication
(10) Pub. No.: US 2022/0354111 A1
(43) Pub. Date: Nov. 10, 2022

(54) EMULSIFIABLE CONCENTRATE CONTAINING ALLYL ISOTHIOCYANATE AND ITS USE AS A NEMATICIDE IN CROP PLANTS

(71) Applicant: ISAGRO S.p.A., Milano (IT)

(72) Inventors: Claudio DACARRO, Milano (IT); Elisa GALIMBERTI, Lissone (MB) (IT); Paolo BELLANDI, Carcare (SV) (IT); Chiara SARGIOTTO, Galliate (NO) (IT)

(21) Appl. No.: 17/624,408

(22) PCT Filed: Jul. 3, 2020
(86) PCT No.: PCT/IB2020/056286

§ 371 Date: Jan. 3, 2022

(30) Foreign Application Priority Data
Jul. 5, 2019 (IT) 102019000011049

(51) Int. Cl. A01N 25/04; A01P 5/00; A01N 47/46; A01N 25/30

(52) U.S. Cl. CPC A01N 25/04; A01P 5/00; A01N 47/46; A01N 25/30

(57) ABSTRACT

The present invention relates to an agrochemical emulsifiable concentrate comprising: —allyl isothiocyanate; —at least one vegetable oil; —at least one non-ionic surfactant; —at least one anionic surfactant. The present invention also relates to the use of the above emulsifiable concentrate as a nematicide in crop plants.

### The present invention relates to an emulsifiable concentrate containing allyl isothiocyanate and its use as a nematicide in crop plants.

### BACKGROUND

The disinfestation or sterilization of an agricultural soil is a practice that allows the soil to be cleaned from both animal and plant parasites that reside there and can cause damage to agricultural crops.

For the realization of this practice, there are different physical or chemical systems, including solarization, the injection of vapour into the soil or treatment with chemical substances that have a fumigating action, said substances also called fumigants which, when appropriately distributed on the soil or incorporated therein, perform an antiparasitic action.

Fumigants are products that have the characteristic of being able to exist in the gaseous state, under certain temperature and pressure conditions, in a concentration and for an amount of time sufficient to allow the elimination of the parasites of interest present in the soil.

However, since fumigants are generally volatile compounds that irritate the skin and eyes, as well as being corrosive and sometimes flammable, they must be decanted from the hermetic containers to the storage tanks and the subsequent application in agriculture must be carried out by specialist operators (professional users) equipped with suitable personal protective devices.

Among the various fumigants currently used, allyl isothiocyanate (AITC) can be mentioned, a compound of natural origin present in mustard oil, known for its excellent fungicidal, bactericidal and nematicidal efficacy.

This substance is traditionally applied by specialist personnel in formulations having very high concentrations of AITC, for example higher than 70% by weight, in order to effectively control the phytopathogens present in the soil.

However, despite the excellent effectiveness of this technique, fumigation is currently a complex process to manage and involves high costs.

In consideration of the above, the Applicant therefore set the objective of identifying a formulation containing relatively low concentrations of allyl isothiocyanate, in particular lower allyl isothiocyanate concentrations than the formulations of the known art, which is therefore easier to use in the agricultural field, but at the same time exhibiting high fumigant efficacy.

In particular, an object of the present invention is to provide an effective formulation that can be used by all operators in the agricultural sector, so as not to have to resort to suitably trained professional users for the use of fumigants.

### DESCRIPTION OF THE INVENTION

The Applicant has now found that the aforementioned and other objects, which will be better illustrated in the following description, can be at least partially overcome by using an emulsifiable concentrate containing allyl isothiocyanate dissolved in at least one vegetable oil. The use of a vegetable oil as a solvent of allyl isothiocyanate allows to obtain emulsifiable concentrates which are surprisingly stable over time and with which it is possible to easily obtain homogeneous and stable oil-in-water emulsions following dilution with water. The emulsifiable concentrates, although containing a relatively low concentration of AITC as an agrochemical active ingredient, exhibit adequate nematicidal activity.

Therefore, a first object of the present invention is an agrochemical emulsifiable concentrate comprising:
allyl isothiocyanate;
at least one vegetable oil;
at least one non-ionic surfactant;
at least one anionic surfactant.

A second object of the present invention is the use of the aforementioned agrochemical emulsifiable concentrate for the control of nematodes in a crop plant.

Preferably, the allyl isothiocyanate is present in the emulsifiable concentrate in an amount within the range from 1% to 70% by weight, more preferably from 5% to 45% by weight, still more preferably from 15 to 25% by weight, with respect to the weight of said emulsifiable concentrate.

Preferably, the vegetable oil is selected from: rapeseed oil, soybean oil, olive oil, castor oil, linseed oil, including derivatives thereof esterified with alkyl groups C₁-C₆.

The esterified derivatives of vegetable oils can be obtained through the transesterification of vegetable oils with short-chain alcohol (C₁-C₆), such as methanol, ethanol, butanol and pentanol, or through the esterification of the fatty acid fractions derived from the saponification of vegetable oils with the same alcohols.

Preferably, said vegetable oil is rapeseed oil, more preferably it is a C₁-C₆ ester of the rapeseed oil, still more preferably it is a methyl ester of said oil.

The vegetable oil is present in the emulsifiable concentrate in an adequate amount to obtain the desired total volume of emulsifiable concentrate. Generally, the vegetable oil is present in the emulsifiable concentrate in an overall amount within the range from 1% to 90% by weight, preferably from 40% to 70% by weight, with respect to the weight of said emulsifiable concentrate.

As mentioned above, the Applicant has found that the use of a vegetable oil as a solvent of the allyl isothiocyanate allows to obtain an emulsifiable concentrate containing this agrochemical active ingredient, which is surprisingly stable over time and has a high propensity to form a homogeneous and stable emulsion following dilution with water.

As is well known to the person skilled in the art, an agrochemical emulsifiable concentrate is a specific type of liquid agronomic formulation in which the agrochemical active ingredient is dissolved in a solvent substantially immiscible with water in the presence of surfactants, such as emulsifiers, wetting agents, antifoams, antifreezes and biological activators, which make it more suitable for use in agriculture.

In accordance with the present invention, the emulsifiable concentrate includes at least one non-ionic surfactant and one anionic surfactant.

The non-ionic surfactant mainly performs the function of emulsifier, i.e. its presence in the emulsifiable concentrate promotes the emulsification of the oil phase with the water used for its dilution, thus making the final, ready to use formulation homogeneous.

Preferably, the at least one non-ionic emulsifying surfactant is selected from: ethoxylated block copolymers, etho-propoxylated block copolymers, ethoxylated tristyrylphenols, etho-propoxylated tristyrylphenols, ethoxylated tristyrylphenols phosphates (acid form), ethoxylated tristyrylphenol sulphates (acid form), sorbitan monolaurates, ethoxylated sorbitan monolaurates, sorbitan mono-oleates, ethoxylated sorbitan mono-oleates, ethoxylated vegetable oil, ethoxylated fatty alcohols, organosilicon compounds and mixtures thereof. More preferably the at least one non-ionic surfactant is a etho-propoxylated tristyrylphenol.

Preferably, the at least one non-ionic surfactant emulsifier is present in the emulsifiable concentrate in an overall amount within the range from 1% to 20% by weight, more preferably from 5% to 15% by weight, with respect to the weight of said emulsifiable concentrate.

Preferably, said at least one anionic surfactant is selected from: ethoxylated tristyrylphenol phosphates (salified form), ethoxylated tristyrylphenol sulphates (salified form), calcium dodecyl benzene sulphonate and mixtures thereof. More preferably, said at least one anionic surfactant is selected from: calcium dodecyl benzene sulphonate and ethoxylated tristyrylphenol phosphates (salified form).

Said at least one anionic surfactant is contained in the emulsifiable concentrate in an overall amount within the range from 1% to 20% by weight, more preferably from 1% to 10% by weight, with respect to the weight of said emulsifiable concentrate.

Optionally, the emulsifiable concentrates according to the present invention can comprise further co-formulants other than those mentioned above, such as for example compounds for improving their biological activity, anti-drift agents, penetrating agents, wetting agents, anti-foaming agents, stabilizers, sequestering agents, anti-corrosion agents, tackifiers and the like.

In a preferred embodiment, the agrochemical emulsifiable concentrate according to the present invention comprising (percentages by weight referring to the weight of the emulsifiable concentrate):
5%-45% by weight, preferably 15%-25% by weight, of allyl isothiocyanate;
5%-15% by weight of at least one non-ionic surfactant;
1%-10% by weight of at least one anionic surfactant;
at least one vegetable oil in an amount equal to the 100% complement by weight of the emulsifiable concentrate.

The preparation of the emulsifiable concentrates of the present invention can be carried out according to methods known to those skilled in the art, by mixing the components in the desired ratios without particular limitations in the mixing order of the components.

For example, in a first step the active ingredient allyl isothiocyanate can be dissolved in the vegetable oil; in a second step, at least one non-ionic surfactant and at least one anionic surfactant are added to the mixture obtained in the first step.

According to an alternative process, the allyl isothiocyanate is added to a mixture comprising a vegetable oil, a non-ionic surfactant and an anionic surfactant.

The emulsifiable concentrates according to the present invention demonstrate a high level of nematicide activity and do not demonstrate phytotoxicity towards the crops to which they are applied.

Furthermore, although their concentration of allyl isothiocyanate is lower than that generally used in the fumigants of the state of the art, the biological effectiveness of the emulsifiable concentrates of the present invention is completely comparable to that of the fumigants of the state of the art. In addition, the emulsifiable concentrate according to the present invention has the advantage of a greater simplicity of application, since it can also be used safely by non-professional users for the treatment of crop plants.

Examples of nematodes that can be controlled with the agrochemical emulsifiable concentrates of the present invention are: Pratylenchus spp., Globodera spp., Heterodera spp., Meloidogyne spp., Aphelenchoides spp., Radopholus similis, Ditylenchus dipsaci, Tylenchulus semipenetrans, Longidorus spp., Xiphinema spp., Trichodorus spp., Bursaphelenchus spp., Belonolaimus spp. and the like.

Examples of crop plants on which it is possible to use the agrochemical emulsifiable concentrates of the present invention for the control of nematodes are: fruit trees, coffee, cocoa, vegetables, turf and extensive crops such as rice, wheat and soybeans.

Another object of the present invention is a method for controlling nematodes in a crop plant which comprises applying at least one effective dose of an agrochemical emulsifiable concentrate of the present description to a crop plant.

The emulsifiable concentrates according to the present invention can be applied, as such or in diluted form, on any part of the plant, for example on leaves, stems, branches and roots, or on the seeds themselves before sowing, or on the soil where the plant will grow.

The emulsifiable concentrates according to the present invention are preferably applied to a crop plant in diluted form with water to form an oil-in-water emulsion.

The emulsifiable concentrate according to the present invention can be used to prepare an oil-in-water emulsion, combining said concentrate with water, optionally in the presence of other ingredients, such as wetting agents, emulsifying agents, etc. The additional ingredients can also be present, or present only in the water used to dilute the emulsifiable concentrate.

A further object of the present invention is therefore a process for preparing an agronomic formulation in the form of an oil-in-water emulsion comprising:
providing at least one emulsifiable concentrate according to the present invention,
diluting said emulsifiable concentrate with water to obtain said agronomic formulation in the form of an oil-in-water emulsion.

Water is added in the amount necessary to achieve the required oil-in-water emulsion volume.

The quantity of emulsifiable concentrate or the relative emulsion to be applied to a crop plant to obtain the desired agrochemical effect can vary depending on various factors such as, for example, the crop, climatic conditions, soil characteristics, the method of application.

In order to better illustrate the present invention, the following embodiment examples are provided, which are to be considered illustrative and non-limiting.

### EXAMPLES

### Example 1

### Emulsifiable Concentrate Containing Allyl Isothiocyanate

The emulsifiable concentrate IRF265-2 was prepared according to the present invention, having the composition shown in Table 1.

The commercial products used for the preparation of the aforementioned oil dispersions are as follows:
Amesolv CME, mixture of methyl esters of rapeseed oil fatty acids;
Soprophor 796/P, etho-propoxylated tristyrylphneol;
Rhodacal 60/BE, calcium salt of benzene sulphonic acid.

TABLE 1

| | IRF265-2 |
|---|---|
| Components | % by weight |
| Allyl isothiocyanate (99.5% | 20 |
| technical) | |
| Amesolv CME (vegetable oil) | 65 |
| Rhodacal 60/BE (anionic surfactant) | 5 |
| Soprophor 796/P (non-ionic | 10 |
| surfactant) | |
| TOTAL | 100 |

The emulsifiable concentrate IRF265-2 was subjected to the accelerated stability test according to Cipac MT 46.1, which aims to accelerate the ageing of a product by heating. This test makes it possible to simulate the stability of a formulation after two years of storage at room temperature.

The following procedure was used: a certain amount of formulation (for example 500 mL) was placed in a hermetically sealed container and left in a heater at 54° C. for 14 days. After this time, the container was removed from the heater and left to return to room temperature. It was therefore visually verified that the formulation did not demonstrate any phase separation or other phenomena of physical instability, such as flocculation, aggregation or crystalline growth. The chemical stability of the active agrochemical ingredient is also verified, as well as the quality of the dispersion subjected to accelerated stability tests, after dilution in water.

The IRF265-2 sample passed the accelerated ageing test, having remained in a homogeneous state at the end of the heat treatment.

### Example 2

### Determination of Nematicide Activity against Phytoparasitic Nematodes

The tests aimed at testing the nematicidal activity of the products under examination were carried out in protected cultivation conditions or in the open field, in soils naturally infested with species of phytoparasitic nematodes. A qualitative-quantitative evaluation of the presence of parasites was carried out by taking and analysing soil samples before the start of the experiments.

The tested products were all applied by fertigation, with hoses having a diameter of 16 mm and a distance between the dispensing holes of 10 cm, connected to a layflat spread on the ground along the entire length of the treated area. The layflat was connected to a pump which withdrew water from the irrigation system and mixed it directly with the product with the Venturi system. Pressure gauges connected at the beginning and end of the layflat allowed to check the water pressure inside the treatment system. The hoses, spread perpendicular to the layflat, were covered with a plastic sheet suitable for the application of fumigant products. Before the treatment, the soil was suitably irrigated, to facilitate the dispersion of the active ingredients in the soil.

The following products were tested:
emulsifiable concentrate IRF265-2 of example 1;
Dominus™, commercial fumigant containing 96.3% AITC by weight;
Vapam™, commercial fumigant containing Metam-sodium at 38.8% by weight.

The tested products were applied, after dilution with water, on bare soil: IRF265-2 and Dominus™ 14 days before sowing or transplanting; Vapam™ according to its label.

The evaluation of the performance of the products comprised: the detection of any phytotoxic effects (using a zero-ten scale where: zero=no symptoms, 10=destroyed plant), the determination of the growth of the plants (measured with a scale of 1-5 or through the NDVI “normalized difference vegetation index”) and effectiveness against the nematode (by analysing the number of J2 larvae present in the soil or by using the Bridge & Page scale to evaluate the root-knot nematode infestation index of the root system).

The following tables show the data collected in tests conducted on different crops and species of nematodes (1 US gal/acre=9.35 l/ha).

Table 2 shows the results of a test on an onion infested with Meloidogyne spp.

TABLE 2

| | | | PLANT | n. J2 |
|---|---|---|---|---|
| | APPLIED | PHYTO- | GROWTH | LARVAE |
| | DOSE | TOXICITY | (NDVI | IN THE |
| COMPOUND | (gal/acre) | (scale 0-10) | index) | SOIL |
| CONTROL | — | — | 0.5 | 109 |
| INFESTED | | | | |
| IRF265-2 | 20 | 0 | 0.7 | 85 |
| | 30 | 0 | 0.8 | 62 |
| | 40 | 0 | 0.8 | 60 |
| DOMINUS ™ | 30 | 0 | 0.8 | 65 |
| VAPAM ™ | 40 | 0 | 0.7 | 78 |

Table 3 shows the results of a test on a potato infested with Meloidogyne chitwoodi.

TABLE 3

| | APPLIED | PHYTO- | PLANT | LARVE J2 |
|---|---|---|---|---|
| | DOSE | TOXICITY | GROWTH | IN THE |
| COMPOUND | (gal/acre) | (scale 0-10) | (scale 1-10) | SOIL |
| CONTROL | — | — | 5 | 115 |
| INFESTED | | | | |
| IRF265-2 | 20 | 0 | 7 | 82 |
| | 30 | 0 | 8 | 60 |
| | 40 | 0 | 8 | 65 |
| DOMINUS ™ | 30 | 0 | 8 | 70 |
| VAPAM ™ | 40 | 0 | 7 | 85 |

Table 4 shows the results of a test on a potato infested with Pratylenchus coffeae.

TABLE 4

| | APPLIED | PHYTO- | PLANT | LARVE J2 |
|---|---|---|---|---|
| | DOSE | TOXICITY | GROWTH | IN THE |
| COMPOUND | (gal/acre) | (scale 0-10) | (scale 1-5) | SOIL |
| CONTROL | — | — | 2 | 505 |
| INFESTED | | | | |
| IRF265-2 | 20 | 0 | 3 | 189 |
| | 30 | 0 | 3.5 | 150 |
| | 40 | 0 | 3.5 | 155 |
| DOMINUS ™ | 30 | 0 | 3.5 | 160 |
| VAPAM ™ | 40 | 0 | 3 | 185 |

Table 5 shows the results of a test on a cucumber infested with Meloidogyne incognita.

TABLE 5

| | | | | ROOT- |
|---|---|---|---|---|
| | | | | KNOT |
| | APPLIED | PHYTO- | PLANT | NEMATODE |
| | DOSE | TOXICITY | GROWTH | INDEX |
| COMPOUND | (gal/acre) | (scale 0-10) | (scale 1-5) | (scale 0-10) |
| CONTROL | — | — | 1.5 | 9 |
| INFESTED | | | | |
| IRF265-2 | 5 | 0 | 3 | 6 |
| | 10 | 0 | 3.5 | 4 |
| | 20 | 0 | 4 | 3.5 |
| DOMINUS ™ | 10 | 0 | 3.5 | 4 |
| VAPAM ™ | 40 | 0 | 3 | 5 |

From the results obtained in the experiments conducted against different nematodes and on different crops, it can be concluded that the product IRF265-2 according to the invention demonstrates efficacy and selectivity fully comparable to the commercial product Dominus™ when applied to the same dose of formulation, although it contains only 20% of the agrochemical active ingredient allyl isothiocyanate.

### Example 3

### Stability Test

The emulsifiable concentrate IRF265-2 was subjected to a further stability test (according to Cipac MT 36) to evaluate the stability of an oil-in-water emulsion of the product after 24 hours. For comparison, some emulsifiable concentrates containing solvents other than vegetable oil were also prepared (Ref.1-Ref.3), which were subsequently subjected to the same stability test. The compositions of the prepared and tested emulsifiable concentrates are shown in table 6.

TABLE 6

| | IRF265-2 | Ref. 1 | Ref. 2 | Ref. 3 |
|---|---|---|---|---|
| | % by | % by | % by | % by |
| Components | weight | weight | weight | weight |
| Allyl isothiocyanate | 20 | 20 | 20 | 20 |
| (99.5% technical) | | | | |
| Amesolv CME | 65 | — | — | — |
| Soprophor 796/P | 10 | 10 | 10 | 10 |
| Rhodacal 60/BE | 5 | 5 | 5 | 5 |
| Propylene glycol | — | 65 | — | — |
| Mineral oil | — | — | 65 | — |
| Butyl lactate | — | — | — | 65 |
| TOTAL | 100 | 100 | 100 | 100 |

For the stability test, the emulsifiable concentrates were poured at a concentration of 5% v/v in standard D Cipac water (hardness 342 ppm), as per the test MT 36. The following procedure was used: fill a 100 ml graduated glass cylinder with 95 ml of standard Cipac D water, add 5 ml of EC formulation and stop the cylinder with a glass stopper. The cylinder is inverted 30 times and left undisturbed at 30° C., observing the stability of the emulsion formed after 30 minutes, 2 hours and 24 hours. The observations relating to the stability of these emulsifiable concentrates after 30 minutes, 2 hours and 24 hours are reported in table 7.

TABLE 7

| | IRF265-2 | Ref. 1 | Ref. 2 | Ref. 3 |
|---|---|---|---|---|
| After 30 | Stable | Oil | Oil | stable |
| min | | separation | separation | |
| After 2 | Stable | 5 mL oil | 5 mL oil | 2-3 mL oil |
| h | | separation | separation | separation |
| | | and emulsion | | |
| | | non- | | |
| | | homogeneity | | |
| After 24 | Stable | n.d. | n.d. | 2-3 mL oil |
| h | | | | separation |

The term “stable” means that no separation of oil or non-homogeneity is detected in the emulsion. The term “n.d.” stands for not determined.

As can be seen from table 7, the emulsifiable concentrate IRF265-2 according to the invention is stable even after 24 hours, while the comparative ones are already unstable after 2 hours.

1. An agrochemical emulsifiable concentrate comprising:
allyl isothiocyanate;
at least one vegetable oil;
at least one non-ionic surfactant;
at least one anionic surfactant.

2. The agrochemical emulsifiable concentrate according to claim 1, wherein said at least one vegetable oil is selected from: rapeseed oil, soybean oil, olive oil, castor oil, linseed oil, including derivatives thereof esterified with C1-C6 alkyl groups.

3. The agrochemical emulsifiable concentrate according to claim 1, wherein said vegetable oil is rapeseed oil, preferably a C1-C6 ester of the rapeseed oil.

4. The agrochemical emulsifiable concentrate according to claim 1, wherein said allyl isothiocyanate is present in an amount comprised in the range between 1% and 70% by weight with respect to the weight of said emulsifiable concentrate.

5. The agrochemical emulsifiable concentrate according to claim 1, wherein said at least one vegetable oil is present in an amount in the range between 1% and 90% by weight with respect to the weight of said emulsifiable concentrate.

6. The agrochemical emulsifiable concentrate according to claim 1, wherein said at least one non-ionic surfactant is selected from the group consisting of: ethoxylated block copolymers, etho-propoxylated block copolymers, ethoxylated tristyrylphenols, etho-propoxylated tristyrylphenols, ethoxylated tristyrylphenol phosphates (acid form), ethoxylated tristyrylphenol sulphates (acid form), sorbitan monolaurates, ethoxylated sorbitan monolaurates, sorbitan mono-oleates, ethoxylated sorbitan mono-oleates, ethoxylated vegetable oil, ethoxylated fatty alcohols, organosilicon compounds and mixtures thereof.

7. The agrochemical emulsifiable concentrate according to claim 1, wherein said at least one non-ionic surfactant is present in the emulsifiable concentrate in an amount in the range from 1% to 20% by weight with respect to the weight of said emulsifiable concentrate.

8. The agrochemical emulsifiable concentrate according to claim 1, wherein said at least one anionic surfactant is selected from the group consisting of: ethoxylated tristyrylphenol phosphates (salified form), ethoxylated tristyrylphenol sulphates (salified form), calcium dodecyl benzene sulphonate and mixtures thereof.

9. The agrochemical emulsifiable concentrate according to claim 1, wherein said at least one anionic surfactant is present in the emulsifiable concentrate in an amount in the range from 1% to 20% by weight with respect to the weight of said emulsifiable concentrate.

10. The agrochemical emulsifiable concentrate according to claim 1 comprising, by weight with respect to the weight of the emulsifiable concentrate:
5%—45% by weight of allyl isothiocyanate;
5%—15% by weight of at least one non-ionic surfactant;
1%—10% by weight of at least one anionic surfactant;
1%—90% of at least one vegetable oil.

11. A process for preparing an agronomic formulation in the form of an oil-in-water emulsion comprising:
providing at least one agrochemical emulsifiable concentrate according to claim 1,
diluting said emulsifiable concentrate with water to obtain said agronomic formulation in the form of an oil-in-water emulsion.

12. A method for controlling nematodes in a crop plant comprising applying at least one effective dose of an agrochemical emulsifiable concentrate according to claim 1 to a crop plant, said concentrate being applied in undiluted form or in diluted form with water to form an oil-in-water emulsion.

13. (canceled)

14. The agrochemical emulsifiable concentrate according to claim 1, wherein said allyl isothiocyanate is present in an amount in the range between 5% and 45% by weight with respect to the weight of said emulsifiable concentrate.

15. The agrochemical emulsifiable concentrate according to claim 1, wherein said allyl isothiocyanate is present in an amount in the range between 15 and 25% by weight with respect to the weight of said emulsifiable concentrate.

16. The agrochemical emulsifiable concentrate according to claim 1, wherein said at least one vegetable oil is present in an amount in the range between 40% and 70% by weight with respect to the weight of said emulsifiable concentrate.

17. The agrochemical emulsifiable concentrate according to claim 1, wherein said at least one non-ionic surfactant is present in the emulsifiable concentrate in an amount in the range from 5% to 15% by weight with respect to the weight of said emulsifiable concentrate.

18. The agrochemical emulsifiable concentrate according to claim 1, wherein said at least one anionic surfactant is present in the emulsifiable concentrate in an amount in the range from 1% to 10% by weight with respect to the weight of said emulsifiable concentrate.

19. The agrochemical emulsifiable concentrate according to claim 10, wherein said allyl isothiocyanate is present in the emulsifiable concentrate in an amount in the range of from 15%-25% by weight with respect to the weight of the emulsifiable concentrate.
